(19) United States
(12) Patent Application Publication
(10) Pub. No.: US 2015/0116521 A1
(43) Pub. Date: Apr. 30, 2015

(54) WIRELESS CONTROL SYSTEMS FOR CAMERAS, CAMERAS WHICH ARE WIRELESSLY CONTROLLED BY CONTROL DEVICES, AND OPERATIONAL METHODS THEREOF

(71) Applicants: Sintai Optical (Shenzhen) Co., Ltd., Shenzhen City (CN); Asia Optical International Ltd., Tortola (GB)

(72) Inventors: Ching-Jung Tsai, Taichung (TW); Shiang-Yin Lin, Taichung (TW)

(21) Appl. No.: 14/526,558

(22) Filed: Oct. 29, 2014

(30) Foreign Application Priority Data
Oct. 29, 2013 (TW) 102139032

(51) Int. Cl. H04N 5/232; H04N 5/3745

(52) U.S. Cl. CPC H04N 5/23203; H04N 5/3745
USPC 348/211.2

(57) ABSTRACT

Wireless control systems for cameras, and operational methods thereof are provided. The system includes a control device and a camera. The camera wirelessly receives a control signal from the control device. The camera captures a plurality of images via an image capture unit, and temporarily stores the images. A processing unit of the camera locates a specific image among the images according to the signal. In some embodiments, the specific image is located among the images according to the time after the time that the control signal is received and an image transmission delay, or according to identification embedded in the control signal.

### BACKGROUND OF THE INVENTION

1. Field of the Invention

The invention relates to a camera and an operational method thereof, and more particularly to a wireless control system for a camera, a camera wirelessly controlled by a control device and an operational method thereof, wherein a problem of the camera unable to synchronize with the control device is solved.

2. Description of the Related Art

As the technology develops, various electronic devices have become indispensable for human's daily life. For example, compact digital cameras can be utilized to take photos, and the photos can be viewed or processed in a related device such as a computer system.

In general, some digital cameras can be remotely controlled. For example, a user can use a remote controller to wirelessly control a digital camera to take photos. Conventionally, transmission between the camera and the remote controller is performed by infrared ray (IR). Since the infrared ray has directionality, the user must operate the remote controller in a specific direction and at a predetermined distance to control the camera. In addition, remote control of conventional cameras is usually limited to photo shot and lack of other functions and applications due to the limitations of the remote controller's related elements and ability.

In some examples, cameras are able to transmit captured images to a control device wirelessly, and a user can determine whether a specific button is pushed to generate a control signal controlling a camera to take photos by viewing the images displayed on the control device. Because transmission of images and signals between the camera and the control device takes time, the camera's action is often unable to synchronize with operation of the control device. In other words, the images viewed on the control device are not the images being captured by the camera, which causes that the captured photos are not the desired photos. The conventional operational method for a camera often cannot satisfy users and even troubles users.

### BRIEF SUMMARY OF THE INVENTION

The invention provides a wireless control system for a camera, a camera wirelessly controlled by a control device and an operational method thereof, wherein a problem of the camera unable to synchronize with the control device is solved.

The wireless control system for a camera in accordance with an exemplary embodiment of the invention includes a control device transmitting a control signal and a camera. The camera includes a wireless transceiving unit configured to wirelessly receive the control signal, an image capture unit configured to capture a plurality of images, a buffer register configured to temporarily store the images, and a processing unit configured to locate a specific image among the images according to the control signal.

The camera wireless controlled by a control device in accordance with an exemplary embodiment of the invention includes a wireless transceiving unit configured to wirelessly receive a control signal from a control device, an image capture unit configured to capture a plurality of images, a buffer register configured to temporarily store the images, and a processing unit configured to locate a specific image among the images according to the control signal.

The wireless operational method for a camera in accordance with an exemplary embodiment of the invention includes: capturing a plurality of images through an image capturing unit and storing the images in a buffer register temporarily; receiving a control signal wirelessly from a control device; and locating a specific image among the images according to the control signal.

The camera wireless controlled by a control device in accordance with an exemplary embodiment of the invention includes an image capture unit configured to capture a plurality of images, a processing unit configured to insert a specific recognition marker into each of the images after the time that each of the images is captured, and a wireless transceiving unit configured to wirelessly transmit each of the images to a control device.

The wireless operational method for a camera in accordance with an exemplary embodiment of the invention includes: capturing a plurality of images through an image capturing unit; inserting a specific recognition marker into each of the images after the time that each of the images is captured; and transmitting each of the images to a control device wirelessly through a wireless transceiving unit.

The wireless control system for a camera, the camera wirelessly controlled by a control device and the operational method thereof of the invention can solve the problem of the control device unable to synchronize with the camera, whereby the images captured by the camera are the very images desired in the control device.

The wireless operational method of the invention can be performed by program codes. When program codes are loaded into a machine, the machine becomes a device capable of performing the operational method of the invention.

### BRIEF DESCRIPTION OF THE DRAWINGS

The invention can be more fully understood by reading the subsequent detailed description and examples with references made to the accompanying drawings, wherein:

FIG. 1 is a block diagram of an embodiment of a wireless control system for a camera of the invention; and

FIG. 2 is a block diagram of an embodiment of a camera of the invention;

FIG. 3 is a flow chart of an embodiment of a method of transmitting images from a camera to a control device of the invention;

FIG. 4 is a flow chart of another embodiment of a method of transmitting images from a camera to a control device of the invention;

FIG. 5 is a flow chart of an embodiment of an operational method for a control device of the invention;

FIG. 6 is a flow chart of an embodiment of a wireless operational method for a camera of the invention;

FIG. 7 is a flow chart of an embodiment of a method of locating a specific image according to a control signal of the invention; and

FIG. 8 is a flow chart of another embodiment of a method of locating a specific image according to a control signal of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

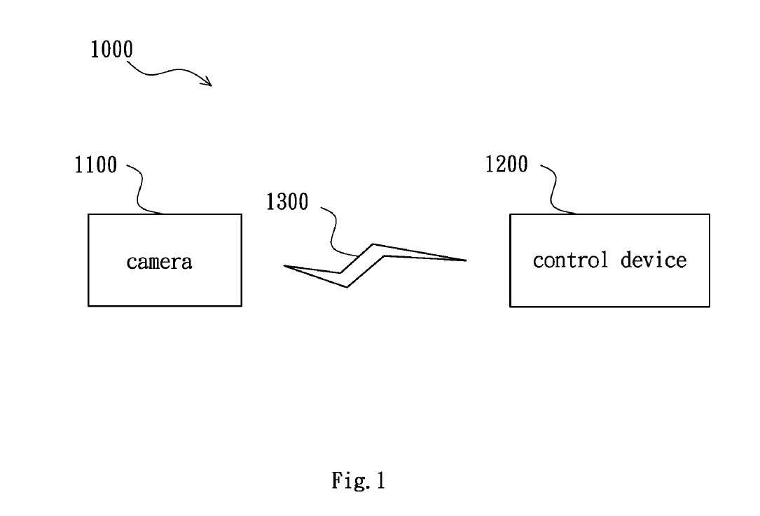

Referring to FIG. 1, a wireless control system 1000 of the invention includes a camera 1100 and a control device 1200. It is noted that in some embodiments the control device 1200 can be an electronic device with wireless connection functions, such as a mobile phone, a smart phone, a personal digital assistant, a global positioning system or a laptop. The control device 1200 can implement a wireless communication protocol, such as IR, WiFi and/or Bluetooth to wirelessly connect to the camera 1100 via a wireless network 1300. It is noted that in some embodiments the control device 1200 includes a display unit to display images received from the camera 1100.

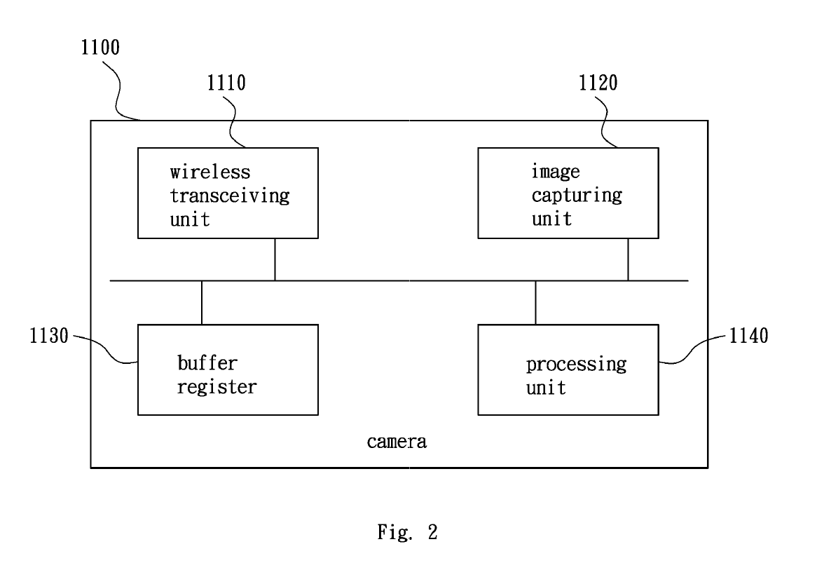

Referring to FIG. 2, the camera 1100 includes a wireless transceiving unit 1100, an image capturing unit 1130, a buffer register 1130 and a processing unit 1140. The wireless transceiving unit 1100 can implement a wireless communication protocol, such as IR, WiFi and/or Bluetooth to wirelessly connect to other electronic devices implementing the same wireless communication protocol. The image capturing unit 1120 can be a charge coupled device (CCD) or a complementary metal-oxide semiconductor (CMOS) and disposed in a position where images are formed in the camera 1100 so as to capture the images. It is noted that in some embodiment, the camera 1100 further includes a display unit displaying related information of the camera 1100, such as the images captured by the image capturing unit 1120, operation interface and/or data. In some embodiments, the camera 1100 further includes a touch control device (not shown) to detect contact on a surface of the touch control device. In some embodiments, the touch control device can be combined with the display unit to constitute a touch display unit. Users can view and input data directly through the touch display unit. The images captured by the image capturing unit 1120 can be temporarily stored in the buffer register 1130. It is known that when the frame rate of the images is lower than 24 frame/sec, stop motion occurs. To prevent this condition, in some embodiments, the buffer register 1130 must have an enough storage capacity for smoothly displaying the images. For example, when the camera 1100 wirelessly transmits images to the control device 1200 at a rate of 24 frame/sec, each image has a file size of 5MB and transmission time between the camera 1100 and the control device 1200 is 1 second, it takes 1 second to display the image, and a shooting command transmitting to the camera 1100 also takes time, thus the total time for displaying the image considering the transmission of the shooting command exceeds 1 second. For example, the time for transmitting shooting command to the camera 1100 is 0.1 second, and thus the total time takes 1.1 second. Therefore, the buffer register need at least 256 MB (256Mb>132MB which is 5MB×24×(1×1.1). The processing unit 1140 controls the operation of software and hardware of the camera 110, which is described as follows.

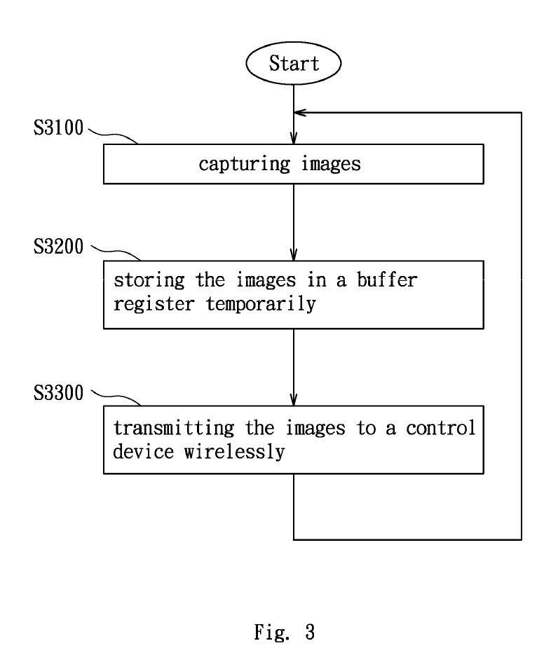

FIG. 3 depicts an embodiment of a method for transmitting images from a camera to a control device of the invention adapted to a digital camera with wireless connection function. In this embodiment, the image captured by a camera is transmitted to control device.

First, as shown in step S3100, images are captured by the image capturing unit 1120 of the camera 1100. After the time that each of images is captured, as shown in step S3200, the images are stored temporarily in the buffer register 1130. In step S3300, the images are wirelessly transmitted to the control device 1200 through a wireless transcieving unit 1110. It is noted that the wireless transcieving unit 1110 can implement a wireless communication protocol, such as IR, WiFi and/or Bluetooth to wirelessly connect to other electronic devices implementing the same wireless communication protocol. In addition, the control device 1200 can be an electronic device with wireless connection functions, such as a mobile phone, a smart phone, a personal digital assistant, a global positioning system or a laptop. The control device 1200 can utilize a wireless connection module which implements a wireless communication protocol, such as IR, WiFi and/or Bluetooth to wirelessly connect the wireless transcieving unit 1110 of the camera 1100, afterwards the process goes back to step S3100.

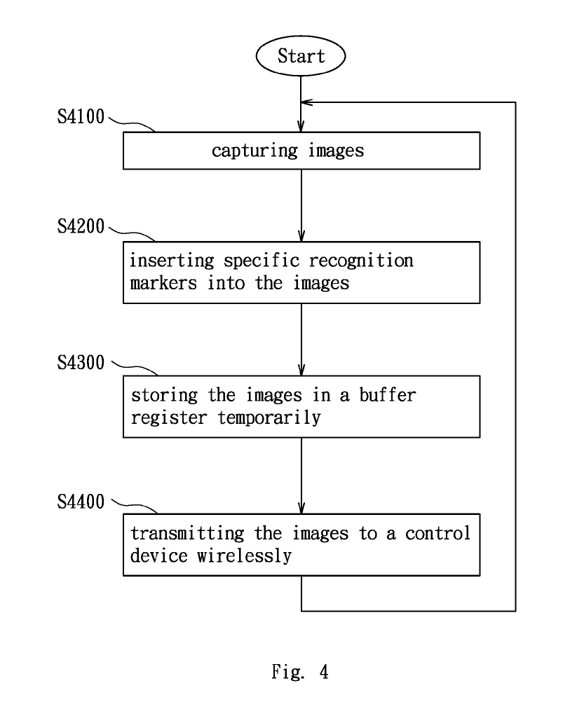

FIG. 4 depicts another embodiment of a method for transmitting images from a camera to a control device of the invention adapted to a digital camera with wireless connection function. In this embodiment, a recognition marker is inserted into each of the images which are transmitted to a control device.

First, as shown in step S4100, images are captured by the image capturing unit 1120 of the camera 1100. After the time that each of the images is captured, as shown in step S4200, a specific recognition marker is inserted into each of the images. In step S4300, the images are stored temporarily in the buffer register 1130. The specific recognition marker corresponding to each of the images is different. In some embodiments, the specific recognition marker can be a sequential number corresponding to the capturing sequence of the images. Afterwards, as shown in step S4400, the images are wirelessly transmitted to the control device 1200 through the wireless transcieving unit 1110. Similarly, the wireless transcieving unit 1110 can implement a wireless communication protocol, such as IR, WiFi and/or Bluetooth to wirelessly connect to other electronic devices implementing the same wireless communication protocol. In addition, the control device 1200 can be an electronic device with wireless connection functions, such as a mobile phone, a smart phone, a personal digital assistant, a global positioning system or a laptop. The control device 1200 can utilize a wireless connection module which implements a wireless communication protocol, such as IR, WiFi and/or Bluetooth to wirelessly connect the wireless transcieving unit 1110 of the camera 1100, afterwards the process goes back to step S4100.

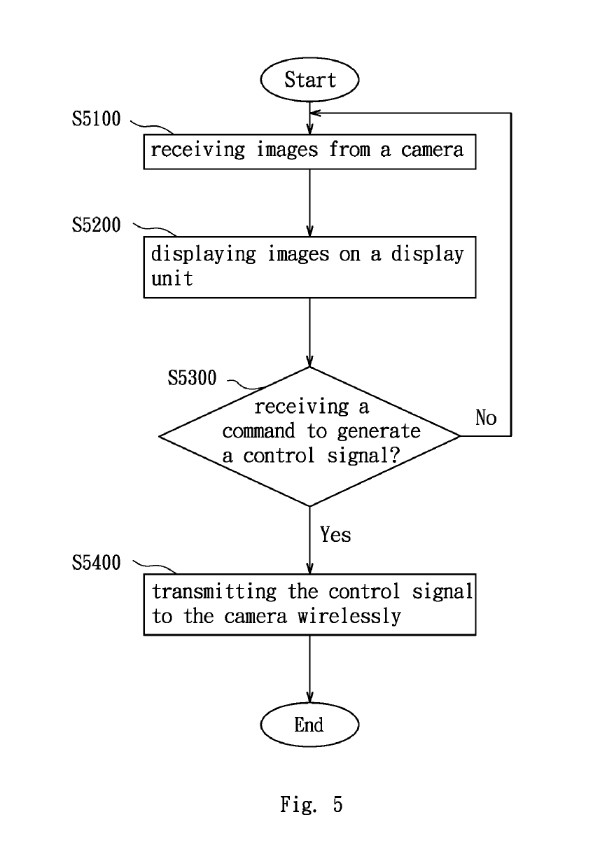

FIG. 5 depicts an embodiment of an operational method for a control device of the invention adapted to an electronic device with wireless connection functions, such as a mobile phone, a smart phone, a personal digital assistant, a global positioning system or a laptop.

As shown in step S5100, the control device 1200 wirelessly receives images. Similarly, the control device 1200 can utilize a wireless connection module implementing a wireless communication protocol such as IR, WiFi and/or Bluetooth to wirelessly connect to the wireless transcieving unit 1110 of the camera 1100 for receiving relate data. In step S5200, the images received from the camera 1100 are displayed on a displaying unit of the control device 1200. Users determine whether a shooting command (push a button) is given to enable the camera 1100 to take photos by viewing the images displayed by the display unit. In step S5300, it is determined whether a command generating a corresponding control signal is received. If the command is not received (“No” of step S5300), then the process goes back to step S5100. If the command is received (“Yes” of step S5300), then as shown in Step S5400, the control device 1200 wirelessly transmits a control signal to the camera 1100. It is noted that in some embodiments, when the control signal is generated, the recognition marker of the image currently shown by the display unit can be removed, inserted to the control signal and transmitted to the camera 1100 along with the control signal.

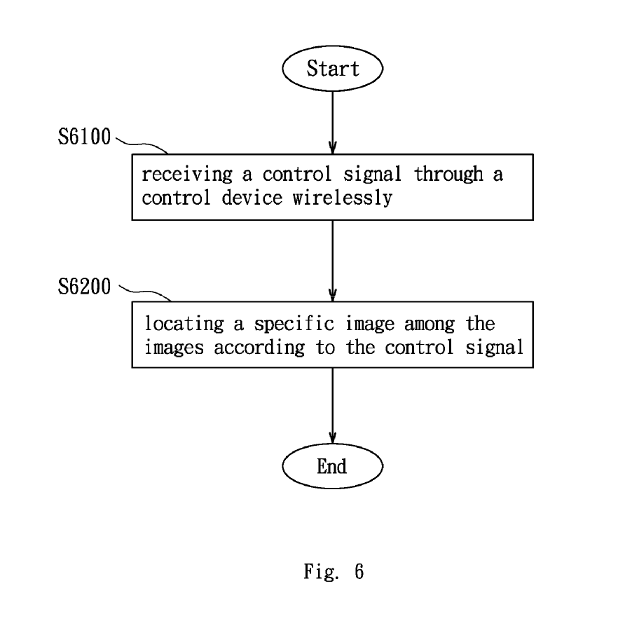

FIG. 6 depicts an operational method for a camera of the invention adapted to a digital camera with wireless connection function. In this embodiment, the camera is able to locate a specific image among the images according to a control signal received from the control device.

As shown in step S6100, the control device 1200 receives a control signal from the control device 1200. Similarly, the wireless transcieving unit 1110 of the camera 100 can implement a wireless communication protocol, such as IR, WiFi and/or Bluetooth to wirelessly connect to other electronic devices implementing the same wireless communication protocol. In addition, the control device 1200 can be an electronic device with wireless connection functions, such as a mobile phone, a smart phone, a personal digital assistant, a global positioning system or a laptop. The control device 1200 can utilize a wireless connection module which implements a wireless communication protocol, such as IR, WiFi and/or Bluetooth to wirelessly connect the wireless transcieving unit 1110 of the camera 1100. Afterwards, as shown in step S6200, a specific image among the images stored in the buffer register 1130 is located according to the control signal. It is noted that the located specific image can be stored permanently, such as stored in a flash memory of the camera 1100. In some embodiments, the images except the located specific image are deleted.

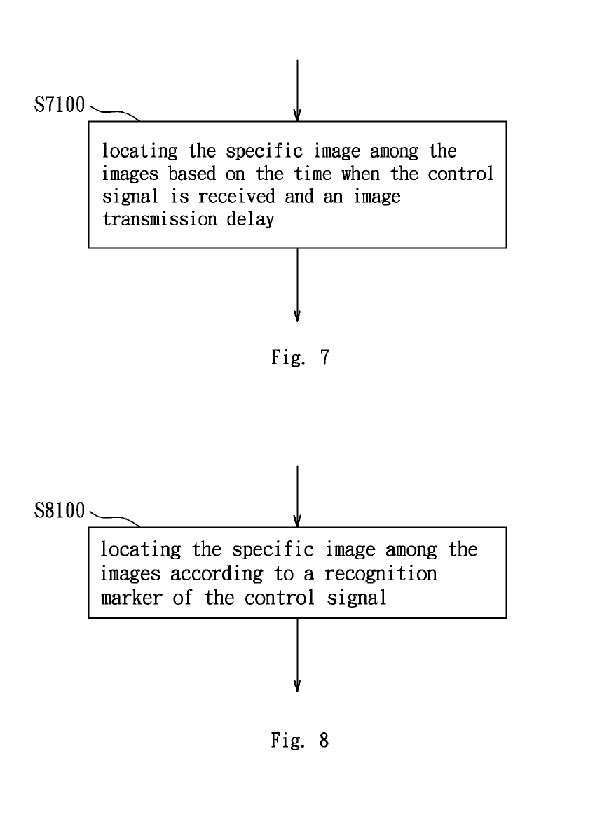

FIG. 7 depicts an embodiment of a method of locating a specific image according to a control signal of the invention. As shown in step S7100, the specific image is located among the images based on the time when the control signal is received and an image transmission delay. For example, when a capture interval between two images is I, the image transmission delay is T and the number of the currently captured image is n, the number of the located specific image among the images is n-T/I.

FIG. 8 depicts another embodiment of a method of locating a specific image according to a control signal of the invention. As shown in step S8100, a recognition marker is obtained from the control signal, and the specific image is located according to the recognition marker. For example, the recognition marker can be a sequential number corresponding to the capturing sequence of the images. When the recognition marker (sequential number) is obtained from the control signal, the obtained recognition marker is compared with the recognition marker of each image. The image having the same recognition marker with the obtained recognition marker(sequential number) is located.

The wireless control system for a camera, the camera wirelessly controlled by a control device and the operational method thereof of the invention can solve the problem of the control device unable to synchronize with the camera, whereby the images captured by the camera are the very images desired in the control device.

The method or other portions of the invention can be presented by program codes. The program codes can be saved in a physical media, such as soft discs, optical discs, hard discs or any other storage media readable by other machine (computer), or can be any type of computer program products. When the program codes are loaded and executed by a machine such as a computer, the machine becomes a device participating in the invention. The program codes can be transmitted through some media such as cable, optical fiber or other transmitting media. When the program codes are loaded and executed by a machine such as a computer, the machine becomes a device participating in the invention. When the program codes are implemented by a general processing unit, the program codes are combined with the processing unit to provide a unique device operated like a device utilizing some specific logic circuits.

What is claimed is:

1. A wireless control system for cameras, comprising:
a control device configured to transmit a control signal; and
a camera comprising:
a wireless transceiving unit configured to wirelessly receive the control signal;
an image capture unit configured to capture a plurality of images;
a buffer register configured to temporarily store the images; and
a processing unit configured to locate a specific image among the images according to the control signal.

2. The wireless control system as claimed in claim 1, wherein the specific image is stored permanently, and the images except the specific image are deleted.

3. The wireless control system as claimed in claim 1, wherein the processing unit further configured to wirelessly transmit each of the images to the control device after the time that each of the images is captured, wherein the control device comprises a display unit to display each of the images.

4. The wireless control system as claimed in claim 3, wherein the display unit comprises a touch control device.

5. The wireless control system as claimed in claim 1, wherein the processing unit locates the specific image among the images based on the time when the control signal is received and an image transmission delay.

6. The wireless control system as claimed in claim 1, wherein the control signal comprises a recognition marker, and the processing unit locates the specific image among the images according to the recognition marker.

7. The wireless control system as claimed in claim 6, wherein each of the image comprises a specific recognition marker, and the specific image is located according to the comparison of the recognition marker with the specific recognition marker.

8. The wireless control system as claimed in claim 6, wherein the image capture unit comprises a charge-coupled device or a complementary metal-oxide semiconductor sensor.

9. A camera wireless controlled by a control device, comprising:
a wireless transceiving unit configured to wirelessly receive a control signal from a control device;
an image capture unit configured to capture a plurality of images;
a buffer register configured to temporarily store the images; and
a processing unit configured to locate a specific image among the images according to the control signal.

10. The camera as claimed in claim 9, wherein the image capture unit comprises a charge-coupled device or a complementary metal-oxide semiconductor sensor.

11. A camera wireless controlled by a control device, comprising:
an image capture unit configured to capture a plurality of images;
a processing unit configured to insert a specific recognition marker into each of the images after the time that each of the images is captured; and
a wireless transceiving unit configured to wirelessly transmit each of the images to a control device.

12. The camera as claimed in claim 11, wherein the image capture unit comprises a charge-coupled device or a complementary metal-oxide semiconductor sensor.

13. A wireless operational method for a camera, comprising:
capturing a plurality of images through an image capturing unit and storing the images in a buffer register temporarily;
receiving a control signal wirelessly from a control device; and
locating a specific image among the images according to the control signal.

14. The wireless operational method as claimed in claim 13 further comprising:
storing the located specific image permanently; and
deleting the images except the specific image.

15. The wireless operational method as claimed in claim 13 further comprising:
transmitting each of the images to the control device wirelessly through the wireless transceiving unit after the time that each of the images is captured, wherein the control unit comprises a display unit to display each of the images.

16. The wireless operational method as claimed in claim 15, wherein the display unit comprises a touch control device.

17. The wireless operational method as claimed in claim 13, wherein the specific image among the images is located according to the time when the control signal is received and an image transmission delay.

18. The wireless operational method as claimed in claim 13, wherein the control signal comprises a recognition marker, and the specific image among the images is located according to the recognition marker.

19. The wireless operational method as claimed in claim 18 further comprising:
inserting a specific recognition marker into each of the images after the time that each of the images is captured; and
comparing the recognition marker of the control signal with the specific recognition marker of each of the images to determine which image is the specific image.

20. A wireless operational method for a camera, comprising:
capturing a plurality of images through an image capturing unit;
inserting a specific recognition marker into each of the images after the time that each of the images is captured; and
transmitting each of the images to a control device wirelessly through a wireless transceiving unit.
